(19) United States
(12) Patent Application Publication
(10) Pub. No.: US 2010/0248766 A1
(43) Pub. Date: Sep. 30, 2010

(54) METHOD OF ALLOCATING RADIO RESOURCES

(76) Inventors: Jin Young Chun, Gyeongki-do (KR); Bin Chul Ihm, Gyeongki-do (KR); Jaewan Kim, Gyeongki-do (KR); Hyun Soo Ko, Gyeongki-do (KR)

Correspondence Address: MCKENNA LONG & ALDRIDGE LLP, 1900 K STREET, NW, WASHINGTON, DC, 20006, US

(21) Appl. No.: 12/675,505

(22) PCT Filed: Sep. 3, 2008
(86) PCT No.: PCT/KR2008/005177

§ 371 Date: Feb. 26, 2010

(30) Foreign Application Priority Data
Sep. 4, 2007 (KR) 10-2007-0089449

(51) Int. Cl. H04W 72/04

(52) U.S. Cl. 455/509

(57) ABSTRACT

A method of allocating radio resources includes allocating radio resources to a first allocation unit which is one of a plurality of allocation units included in a resource domain, and allocating radio resources to a second allocation unit at the m th position in a time domain and at the n th position in a frequency domain from the first allocation unit, wherein the resource domain includes a plurality of allocation unit groups, the plurality of allocation unit groups are composed the plurality of allocation units placed m in the time domain and n in the frequency domain from a previous allocation unit.

### TECHNICAL FIELD

The present invention relates to wireless communication and more particularly, to a method for allocating radio resources capable of obtaining diversity effect in time domain and frequency domain.

### BACKGROUND ART

A wireless communication system is commonly used to provide a variety of types of communication services. For example, voice and/or data are provided by the wireless communication system. A general wireless communication system provides one or more shared resources to multiple users. For example, the wireless communication system may employ various multi-access schemes such as code division multiple access (CDMA), time division multiple access (TDMA), frequency division multiple access (FDMA), or the like.

The OFDM uses a plurality of orthogonal subcarriers. The OFDM uses orthogonality between inverse fast Fourier transform (IFFT) and fast Fourier Transform (FFT). A transmitter performs IFFT on data and transmits the same. A receiver performs FFT on a reception data to restore the original data. The transmitter uses IFFT to combine multiple subcarriers, and in order to separate the multiple subcarriers, the receiver uses the corresponding FFT. According to the OFDM, complexity of the receiver can be reduced in a frequency selective fading environment of a broadband channel and spectral efficiency can be increased through selective scheduling or the like in a frequency domain by utilizing different channel characteristics of each subcarrier. Orthogonal Frequency Division Multiple Access (OFDMA) is a multi-access scheme based on the OFDM. According to the OFDMA, the efficiency of radio resources can be enhanced by allocating different subcarriers to multiple users.

Hereinafter, downlink refers to communication from a base station to a mobile station, and uplink (UL) refers to communication link from the mobile station to the base station.

In general, the base station allocates radio resources to the mobile station. The radio resources become uplink resources in the uplink and downlink resources in the downlink. The radio resources allocated to the mobile station may be allocated distributively in a frequency domain or in a time domain. Transmission of data through radio resources distributed in the frequency domain refers to frequency diversity. The frequency diversity can improve data rate by distributing an influence of fading caused in a particular frequency band. Transmission of data through radio resources distributed in a time domain refers to time diversity. The time diversity, which allows transmission of same data several times at certain time intervals, can improve data rate by reducing an influence of fading according to time.

A method for allocating radio resources that can obtain the time diversity gain and the frequency diversity gain is required.

### DISCLOSURE OF INVENTION

### Technical Problem

The present invention provides a method of allocating radio resources capable of obtaining a diversity effect in a time domain and a frequency domain.

### Technical Solution

In an aspect, a method of allocating radio resources includes allocating radio resources to a first allocation unit which is one of a plurality of allocation units included in a resource domain, and allocating radio resources to a second allocation unit at the m th position in a time domain and at the n th position in a frequency domain from the first allocation unit, wherein the resource domain includes a plurality of allocation unit groups, the plurality of allocation unit groups are composed the plurality of allocation units placed m in the time domain and n in the frequency domain from a previous allocation unit.

In another aspect, a method of allocating a plurality of subchannels to a MS includes allocating a first subchannel to the MS, and allocating a second subchannel by shifting from the first subchannel in units of subchannel in a time domain and a frequency domain, wherein the plurality of subchannels are included in a resource domain.

### ADVANTAGEOUS EFFECTS

According to the present invention, both the time diversity gain and the frequency diversity gain can be obtained. A single carrier system can be easily applicable, because the radio resources, which is contiguous in frequency domain, are allocated to one mobile station. Thus, the diversity gain can be obtained along with the low Peak-to-Average Power Ratio (PAPR), the advantage of the single carrier system.

### BRIEF DESCRIPTION OF THE DRAWINGS

FIG. 1 shows a wireless communication system.

FIG. 2 shows an example of the structure of a frame structure.

FIG. 3 shows a resource domain and allocation units according to an embodiment of the present invention.

FIG. 4 shows a radio resource allocation method according to one embodiment of the present invention.

FIG. 5 shows a radio resource allocation method according to another embodiment of the present invention.

FIG. 6 shows an example of allocating radio resources to a plurality of mobile stations according to the radio resource allocation method according to an embodiment of the present invention.

FIG. 7 shows the structure of a subchannel according to an embodiment of the present invention.

FIG. 8 shows a radio resource allocation method according to another embodiment of the present invention.

### MODE FOR THE INVENTION

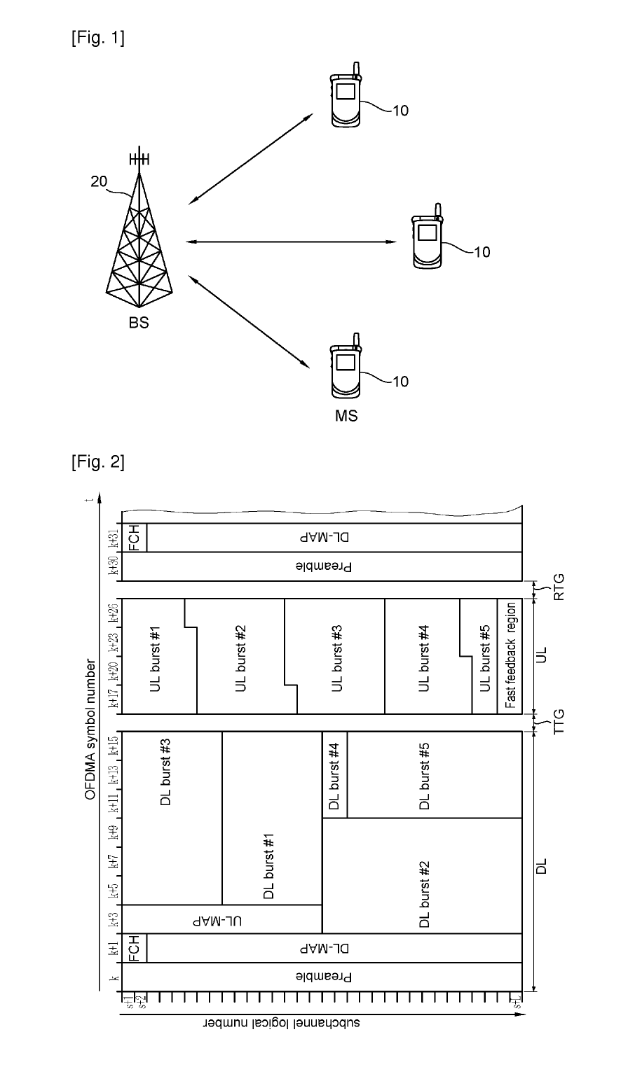

FIG. 1 shows a wireless communication system. The wireless communication system can be widely deployed to provide a variety of communication services, such as voices, packet data, etc.

Referring to FIG. 1, the wireless communication system includes at least one mobile station (MS) 10 and a base station (BS) 20. The UE 10 may be fixed or mobile, and may be referred to as another terminology, such as a user equipment (UE), a user terminal (UT), a subscriber station (SS), a wireless device, etc. The BS 20 is generally a fixed station that communicates with the UE 10 and may be referred to as another terminology, such as a node-B, a base transceiver system (BTS), an access point, etc. There are one or more cells within the coverage of the BS 20.

Suggested radio resource allocating method may be applied to an uplink transmission or a downlink transmission. Hereinafter, a frame can become an uplink frame in the uplink transmission, and become a downlink frame in the downlink transmission. The frame may include the uplink frame and the downlink frame. For the uplink transmission and downlink transmission, a Time Division Duplex (TDD) in which transmission is made by using each different time may be used, or a Frequency Division Duplex (FDD) in which transmission is made by using each different frequency may be used.

FIG. 2 shows an example of a frame structure. A frame is a data sequence used according to a physical specification in a fixed time duration. The frame may be an OFDMA frame.

Referring to FIG. 2, the frame includes a downlink (DL) frame and an uplink (UL) frame. When a time division duplex (TDD) scheme is used, UL and DL transmissions share the same frequency but are performed in different time periods. The DL frame is temporally prior to the UL frame. The DL frame includes a preamble, a frame control header (FCH), a DL-MAP, a UL-MAP, and a DL burst region. The UL frame includes a UL burst region.

Guard times are provided to identify the UL frame and the DL frame and are inserted to a middle portion (between the DL frame and the UL frame) and a last portion (next to the UL frame) of the frame. A transmit/receive transition gap (TTG) is a gap between a DL burst and a subsequent UL burst. A receive/transmit transition gap (RTG) is a gap between a UL burst and a subsequent DL burst.

A preamble is used between a BS and a MS for initial synchronization, cell search, and estimation of a frequency offset and a channel. An FCH includes information regarding a length of a DL-MAP message and a coding scheme of the DL-MAP. The DL-MAP is a region where the DL-MAP message is transmitted. The DL-MAP message defines a connection of a DL channel. The DL-MAP message includes a configuration change count of a downlink channel descriptor (DCD) and a BS identifier (ID). The DCD describes a DL burst profile applied to a current MAP. The DL burst profile indicates characteristics of a DL physical channel. The DCD is periodically transmitted by the BS by using a DCD message. The UL-MAP is a region where a UL-MAP message is transmitted. The UL-MAP message defines a connection of a UL channel. The UL-MAP message includes a configuration change count of an uplink channel descriptor (UCD) and also includes an effective start time of UL assignment defined by the UL-MAP. The UCD describes a UL burst profile. The UL burst profile indicates characteristics of a UL physical channel and is periodically transmitted by the BS by using a UCD message.

Hereinafter, a slot is a minimum possible data allocation unit and defined as time and a subchannel. In the UL, subcarrier may include a plurality of tiles. The subcarrier may include six tiles and in the UL, one burst may include three OFDM symbols and one subcarrier.

In a Partial Usage of Subchannels (PUSC) permutation, each tile may include four contiguous subcarriers on three OFDM symbols. Subcarriers of the PUSC may include eight data subcarriers and four pilot subcarriers. In an optional PUSC permutation, each time may include three contiguous subcarriers on three OFDM symbols. Subcarriers of the optional PUSC may include eight data subcarriers and one pilot subcarrier. The tiles included in the subchannels are distributed to every band so as to be disposed.

A bin includes nine contiguous subcarriers on the OFDM symbol. A band refers to a group of four rows of the bin, and Adaptive Modulation and Coding (AMC) subcarrier includes six contiguous bins in the same band.

A resource domain for allocating radio resources to an MS and an allocation unit, and a method for allocating radio resources by using the same will now be described. In the following description, it is assumed that uplink resources are allocated, but DL resources may be also allocated in the same manner.

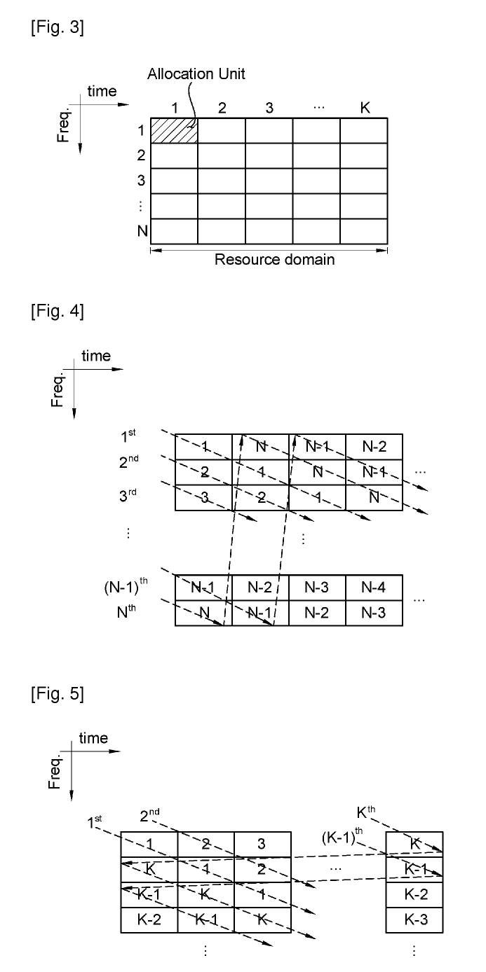

FIG. 3 shows a resource domain and allocation units according to an embodiment of the present invention.

Referring to FIG. 3, the resource domain may include a plurality of allocation units. The resource domain may include the K number of allocation units in a time domain and the N number of allocation units in a frequency domain (K≧1, N≧1, K and N are integers). The resource domain may include the K time units in the time domain and the N frequency units in the frequency domain. The resource domain may have the square structure of K×N, but it is merely an example and may have various other shapes.

The resource domain is a physical radio resource domain for allocating data with respect to at least one MS. The resource domain may be expressed as a certain OFDMA symbol interval and a certain subchannel interval in a frame. Data with respect to the MS may be user data or control information for receiving user data. The resource domain may be a domain from which a UL frame or a single UL burst is physically allocated in the UL. The resource domain may be a domain from which a DL frame or a single DL burst is physically allocated.

An allocation unit is a basic unit for allocating radio resources. The allocation unit may be a subchannel. In this case, the subchannel may include six successive tiles. The subchannel may correspond to a subband, a resource block, or the like. The allocation unit may be an AMC subchannel including six successive bins. The allocation unit may be a 1/2 subchannel including three successive tiles.

The method for allocating radio resources to the MS by using the allocation unit within the resource domain will now be described. It is assumed that the allocation unit is a subchannel.

FIG. 4 shows a radio resource allocation method according to an embodiment of the present invention.

Referring to FIG. 4, it is assumed that the resource domain includes the N number of subchannels in the frequency domain (N>1 and integer). For description, positions (time domain order, frequency domain order) of the subchannels are expressed. For example, the position of a first channel in the time domain and the frequency domain is expressed as (1,1), and the position of a subchannel which comes first in the time domain and the N th in the frequency domain is expressed as (1,N). If subchannels have the same time domain order, it means that they are transmitted at the same time, and if subchannels have the same frequency domain order, it means that they are transmitted at the same frequency band.

Subchannels are diagonally allocated with respect to the time domain and the frequency domain. The first subchannel is allocated to (1,1), and shifting is made by 1 in the time domain and 1 in the frequency domain to continuously allocate subchannels. That is, subsequently, a second subchannel is allocated to (2,2). A next subchannel is allocated to a position which is diagonal to the previously allocated subchannel.

The subchannels allocated by (1,1), (2,2), (3,3), . . . are called a first subchannel group. Subchannels allocated by (1,2), (2,3), (3,4), . . . are called a second subchannel group. Because the resource domain has the N subchannels in the frequency domain, N subchannel groups may include in the resource domain. The resource domain may include the N subchannel groups.

Subchannels of each subchannel group are sequentially allocated, and when it reaches the N th subchannel in the frequency domain, it is hopped to a first subchannel of the frequency domain and a next subchannel is allocated. For example, after a first subchannel of (1,N) of the N th subchannel group is allocated, it is hopped and a subchannel of (2,1) is allocated, and subchannels of (3,2), (4,3), . . . , are successively allocated. Subchannels of the (N−1) th subchannel group are allocated by (1,N−1), (2,N), (3,1), (4,2), . . . . Allocation by hopping to a first subchannel of the frequency domain after the N th subchannel of the frequency domain is allocated continues until it reaches a final subchannel of each subchannel group in the time domain. In this manner, the subchannels included in the resource domain may be allocated in one of the N number of subchannel groups without omission.

In case of allocating subchannels to a plurality of MSs, subchannels included in a first subchannel group may be sequentially allocated to a first MS. If the number of subchannels to be allocated to the first MS is larger than the number of subchannels included in the first subchannel group, subchannels included in a second subchannel group may be allocated to the first MS. If the number of subchannels to be allocated to the first MS is smaller than the number of subchannels included in the first subchannel group, the subchannels of the first subchannel group are sequentially allocated to the first MS, and subsequently, the remaining subchannels of the first subchannel group are allocated to a second MS. That is, in case of allocating subchannels to a plurality of MSs, subchannels that follow those allocated to the former MS are subsequently and successively allocated to the next MS. According to this method, a BS can inform the MSs about the number of subchannels to be allocated to the MSs, whereby the BS and the MSs may know about the positions and a range of the allocated subchannels.

In the above description, the position of the next subchannel following the previously allocated subchannel is a position which has been shifted by 1 in the time domain and shifted by 1 in the frequency domain, but this is merely an example and is not limited thereto. The position of the next subchannel of the previously allocated subchannel may be one shifted by n in the time domain and by m in the frequency domain (n≧1, m≧1, m and n are integers). For example, the position may be shifted by 1 in the time domain and by 2 in the frequency domain, according to which the next subchannel following the subchannel of (1,1) may be (2,3). In addition, a first subchannel of each subchannel group may start from the first order of the frequency domain (x,1), rather than not starting from the first order of the time domain (1,x).

FIG. 5 shows a radio resource allocation method according to another embodiment of the present invention.

Referring to FIG. 5, it is assumed that the resource domain has the K subchannels in the time domain (K>1, is an integer).

The subchannels of the first subchannel group are allocated starting from (1,1), (2,2), (3,3), . . . . The subchannels of the second subchannel group are allocated starting from (2,1), (3,2), (4,3), . . . . The resource domain may include the K subchannel groups from the first subchannel group to the K th subchannel group.

Subchannels of each subchannel group are sequentially allocated, and when it reaches the K th subchannel in the time domain, it is hopped to a first subchannel of the time domain and a next subchannel is allocated. For example, after a first subchannel of (K,1) of the K th subchannel group is allocated, it is hopped and a subchannel of (1,2) is allocated, and subchannels of (2,3), (3,4), . . . are successively allocated. Such allocation by hopping to the first subchannel of the time domain after the K th subchannel of the time domain is allocated continues until it reaches a final subchannel of each subchannel group in the frequency domain. The subchannels included in the resource domain may be allocated in one of the K subchannel groups without omission.

In the above description, the position of the next subchannel following the previously allocated subchannel is a position which has been shifted by 1 in the time domain and shifted by 1 in the frequency domain, but this is merely an example and is not limited thereto. The position of the next subchannel of the previously allocated subchannel may be one shifted by n in the time domain and by m in the frequency domain (n>1, m>1, n and m are integers). In addition, the case where the resource domain has the N subchannels in the frequency domain and the case where the resource domain has the K subchannels in the time domain have been separately described, but those are merely examples, and even when the resource domain has the N subchannels in the frequency domain and the K subchannels in the time domain, the subchannels may be allocated according to the method of using the N subchannel groups and the method of using the K subchannel groups.

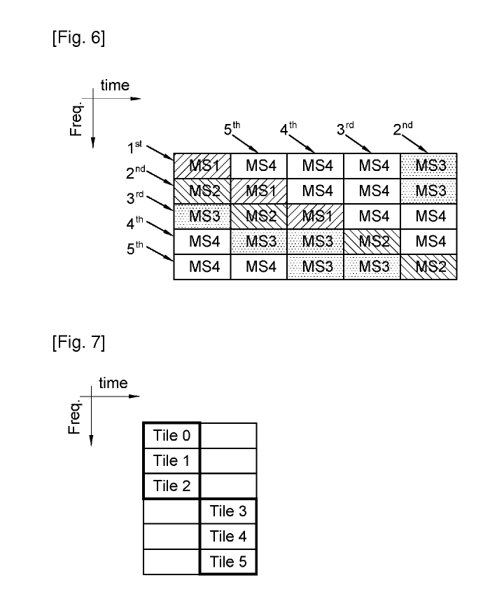

FIG. 6 shows an example of allocating radio resources to a plurality of MSs according to the radio resource allocation method according to an embodiment of the present invention.

Referring to FIG. 6, it is assumed that the resource domain includes five subchannels in the time domain and five subchannels in the frequency domain. Here, a first subchannel group includes subchannels of (1,1), (2,2), (3,3), (4,4), and (5,5), a second subchannel group includes subchannels of (1,2), (2,3), (3,4), (4,5), and (5,1), a third subchannel group includes subchannels of (1,3), (2,4), (3,5), (4,1), and (5,2), a fourth subchannel group includes subchannels of (1,4), (2,5), (3,1), (4,2), and (5,3), and a fifth subchannel group includes subchannels of (1,5), (2,1), (3,2), (4,3), and (5,4).

It is assumed that three subchannels are allocated to a first MS (MS1), four subchannels to a second MS (MS2), seven subchannels to a third MS (MS3), and eleven subchannels to a fourth MS (MS4). The subchannels are sequentially allocated to the respective MS along the subchannel groups. The subchannels of (1,1) to (3,3) of the first subchannel group are allocated to the first MS. The subchannels of (4,4) and (5,5) of the first subchannel group and the subchannels of (1,2) and (2,3) of the second subchannel group are allocated to the second MS.

The subchannels of (3,4), (4,5), and (5,1) of the second subchannel group and the subchannels of (1,3), (2,4), (3,5), and (5,2) of the third subchannel group are allocated to the third MS. Here, the subchannel (4,1) is supposed to be allocated following the subchannel (3,5) of the third subchannel group, but the third MS has been allocated the subchannel (4,5) and in order to allocate only a contiguous subchannel in the same time unit, the subchannel (4,1) is not allocated but the next subchannel (5,2) is allocated. That is, when a plurality of subchannels are allocated to one MS, the subchannels are allocated such that they are not distributed in the frequency domain but contiguous in the same time unit.

By allocating the subchannels to one MS such that they are continuous in the frequency domain in the same time unit, it can be applied to the single carrier system. The single carrier system is a system for including data in a single carrier and transmitting the same by using Discrete Fourier Transform (DFT) and Inverse Fast Fourier Transform (IFFT). The single carrier system includes Single Carrier-Frequency Division Multiple Access (SC-FDMA) system. The single carrier system has an advantage that the Peak-to-Average Power Ratio (PAPR) of a transmission signal can be lowered. But the single carrier system has a disadvantage that because a resource domain contiguous to the frequency domain should be allocated to a MS, a diversity effect cannot be obtained. According to suggested method, when subchannels are allocated to the MS such that they are contiguous in the frequency domain in the same time unit while shifting the subchannels in the time domain and the frequency domain, both the lower PAPR, the advantage of the single carrier system, and the diversity gain can be obtained.

To the fourth MS, the subchannel (4,1) of the third subchannel group, which has not been allocated to the third MS but passed over, and subchannels of the fourth subchannel group and subchannels of the fifth subchannel group are allocated.

A method for allocating radio resources when an allocation unit of the resource domain is three successive tiles will now be described.

FIG. 7 shows the structure of a subchannel according to an embodiment of the present invention.

Referring to FIG. 7, the allocation unit may be the three successive tiles. Radio resources may be allocated to a MS in units of the three contiguous tiles (1/2 subchannel). Alternatively, the radio resources may be allocated by subchannels such that three tiles are successively disposed in the frequency domain in one time unit while the other remaining three tiles may be successively disposed in the frequency domain in a another time unit. The respective three successive tiles are diagonally positioned with respect to the time domain and the frequency domain to thus obtain time diversity and frequency diversity.

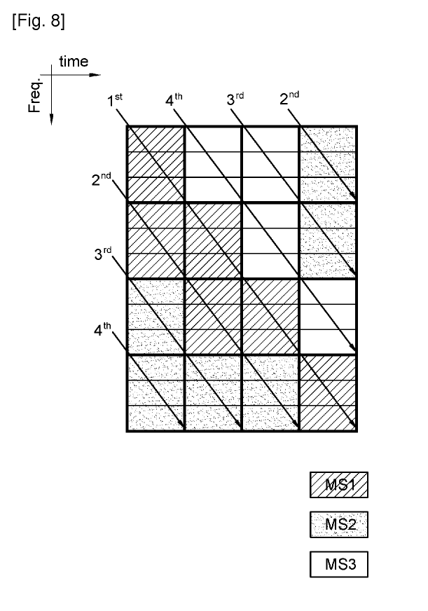

FIG. 8 shows a radio resource allocation method according to another embodiment of the present invention.

Referring to FIG. 8, it is assumed that a resource domain includes four subchannels in the time domain and four 1/2 subchannels in the frequency domain, and an allocation unit is three successive tiles (1/2 subchannels). In this case, the position of the allocation unit is expressed by the time domain order or the frequency domain order, and herein, the frequency domain order is 1/2 subchannel unit.

A first subchannel group includes 1/2 subchannels of (1,1), (2,2), (3,3), and (4,4), a second subchannel group includes 1/2 subchannels of (1,2), (2,3), (3,4), and (4,1), a third subchannel group includes 1/2 subchannels of (1,3), (2,4), (3,1), and (4,2), and a fourth subchannel group includes 1/2 subchannels of (1,4), (2,1), (3,2), and (4,3).

It is assumed that three subchannels are allocated to the first MS (MS1), three subchannels to the second MS (MS2), and two subchannels to the third MS (MS3). To the first MS, 1/2 subchannels of (1,1) to (4,4) of the first subchannel group and 1/2 subchannels of (1,2) and (2,3) of the second subchannel group are allocated. To the second MS, 1/2 subchannels of (3,4) and (4,1) of the second subchannel group and 1/2 subchannels of (1,3), (2,4), and (4,2) of the third subchannel group and 1/2 subchannels of (1,4) of the fourth subchannel group are allocated. In this case, 1/2 subchannels of (3,1) are not allocated so that the radio resources can be successively allocated to the second MS. To the third MS, 1/2 subchannels of (3,1) of the third subchannel group, which has not been allocated to the second MS but passed over, and 1/2 subchannels of (2,1), (3,2), and (4,3) of the fourth subchannel group are allocated.

The number of allocation units is merely an example, and it can be N in the time domain and K in the frequency domain (N>1, K>1, N and K are integers). In addition, the position of a next allocation unit of a previously allocated allocation unit may be a position which has been shifted by n in the time domain and by m in the frequency domain (n≧1, m≧1, n and m are integers).

Every function as described above can be performed by a processor such as a micro-processor based on software coded to perform such function, a program code, etc., a controller, a micro-controller, an ASIC (Application Specific Integrated Circuit), or the like. Planning, developing and implementing such codes may be obvious for the skilled person in the art based on the description of the present invention.

Although the embodiments of the present invention have been disclosed for illustrative purposes, those skilled in the art will appreciate that various modifications, additions and substitutions are possible, without departing from the scope of the invention. Accordingly, the embodiments of the present invention are not limited to the above-described embodiments but are defined by the claims which follow, along with their full scope of equivalents.

1. A method of allocating radio resources, the method comprising:
allocating radio resources to a first allocation unit which is one of a plurality of allocation units included in a resource domain; and
allocating radio resources to a second allocation unit at the m th position in a time domain and at the n th position in a frequency domain from the first allocation unit, wherein the resource domain includes a plurality of allocation unit groups, the plurality of allocation unit groups are composed the plurality of allocation units placed m in the time domain and n in the frequency domain from a previous allocation unit (m≧1, n≧1, m and n are integers).

2. The method of claim 1, wherein the plurality of allocation units allocated to one MS in the resource domain are contiguous in the frequency domain in the same time unit.

3. The method of claim 1, wherein the first allocation unit is allocated to one MS and the second allocation unit is allocated to other MS.

4. The method of claim 1, wherein the allocation unit is a subchannel.

5. The method of claim 1, wherein the allocation unit is three contiguous tiles.

6. The method of claim 1, further comprising:
informing a number of the allocation units allocated to MSs, wherein the number of the allocation units represent positions of the allocation units.

7. A method of allocating a plurality of subchannels to a MS, the method comprising:
allocating a first subchannel to the MS; and
allocating a second subchannel by shifting from the first subchannel in units of subchannel in a time domain and a frequency domain, wherein the plurality of subchannels are included in a resource domain.

8. The method of claim 7, when the first subchannel is a last subchannel in the frequency domain of the resource domain, the second subchannel is hopped to the first subchannel in the frequency domain of the resource domain.

9. The method of claim 7, when the first subchannel is a last subchannel in the time domain of the resource domain, the second subchannel is hopped to the first subchannel in the time domain of the resource domain.

10. The method of claim 7, wherein the plurality of subchannels comprise contiguous tiles.
